(19) United States
(12) Patent Application Publication
(10) Pub. No.: US 2016/0341759 A1
(43) Pub. Date: Nov. 24, 2016

(54) SENSOR AND METHOD OF MANUFACTURING SAME

(71) Applicant: KYOCERA CORPORATION, Kyoto-shi (JP)

(72) Inventors: Tokuichi YAMAJI, Nara-shi (JP); Yuko YOKOTA, Kizukawa-shi (JP); Atsuo HATATE, Nara-shi (JP); Hiroki ISHIKAWA, Kizukawa-shi (JP); Takeshi SUZUKI, Toyohashi-shi (JP); Hideaki ASAO, Soraku-gun (JP)

(21) Appl. No.: 15/114,369

(22) PCT Filed: Jan. 26, 2015
(86) PCT No.: PCT/JP2015/052022

§ 371 Date: Jul. 26, 2016

(30) Foreign Application Priority Data
Jan. 28, 2014 (JP) 2014-013026

(51) Int. Cl. G01P 15/12; G01P 15/18; G01D 11/30; G01L 9/00; G01L 19/00; G01P 15/08

(52) U.S. Cl. CPC G01P 15/123; G01L 19/0092; G01P 15/0802; G01D 11/30; G01L 9/0054; G01P 15/18

(57) ABSTRACT

A sensor comprising: a mass element; a frame surrounding the mass element; a connecting body having flexibility, and connecting the mass element to the frame; a pressure detecting unit; and an acceleration detecting unit. The mass element comprises: a main portion comprising a through-hole passing therethrough from the top surface to the bottom surface; a mounting portion connected to the top surface of the main portion, and surrounding an outer periphery of the through-hole; a first cover portion having flexibility, connected to the mounting portion and covering the through-hole; and a second cover portion, disposed on the bottom surface of the main portion, covering the through-hole, and deformable less than the first cover portion when received an external force. The pressure detecting unit is disposed on the first cover portion and configured to detect, with an electrical signal, bending in the first cover portion caused by an air pressure difference between an outside pressure and an airtight space that is defined by the main portion, the first cover portion, the second cover portion, and the mounting portion. The acceleration detecting unit is disposed on the connecting body and configured to detect, with an electrical signal, bending in the connecting body.

### TECHNICAL FIELD

The present invention relates to a sensor capable of detecting at least an air pressure and an acceleration, and to a method of manufacturing the same.

### BACKGROUND ART

Sensors for detecting various types of physical quantities are being incorporated into various types of electronic equipment in recent years. To incorporate sensors into electronic equipment, there is demand for the sensors themselves to be made smaller, and small-size sensors that employ semiconductor chips are in wide use.

For example, an acceleration sensor configured by forming a piezo resistive element on a semiconductor substrate (see Patent Document 1: Japanese Unexamined Patent Application Publication No. H03-2535), a method of manufacturing such an acceleration sensor (see Patent Document 2: Japanese Unexamined Patent Application Publication No. H04-81630), and a pressure sensor of a type in which a piezo resistive element is formed upon a semiconductor diaphragm (see Patent Document 3: Japanese Unexamined Patent Application Publication No. H11-142270) have been proposed.

However, the sensors employing the techniques disclosed in Patent Documents 1 to 3 are each capable of sensing a single physical quantity, and it has thus been necessary to incorporate a plurality of sensors into electronic equipment in the cases where it is necessary to sense multiple physical quantities. In other words, sensing two types of physical quantities makes it necessary to provide a mounting surface area twice the size of a single sensor, which has made it difficult to fully respond to demand for making the electronic equipment smaller.

On the other hand, acceleration and pressure are both basic physical quantities, and there are many types of electronic equipment that function by detecting both.

Having been conceived in light of the above-described circumstances, an object of the present invention is to provide a sensor capable of detecting an acceleration and an air pressure using a single structure, and to provide a method of manufacturing the same.

### SUMMARY OF INVENTION

A sensor according to an embodiment of the present invention includes a mass element, a frame surrounding the mass element in a top surface view, a connecting body having flexibility, and connecting a top portion of the mass element to a top portion of the frame, a pressure detecting unit, and an acceleration detecting unit.

The mass element includes a main portion including a top surface, a bottom surface, and a through-hole passing therethrough from the top surface to the bottom surface, a mounting portion connected to the top surface of the main portion and surrounding an outer periphery of the through-hole, a first cover portion having flexibility, connected to the mounting portion and covering the through-hole, and a second cover portion, disposed on the bottom surface of the main portion, covering the through-hole, and deformable less than the first cover portion when received an external force.

Furthermore, the pressure detecting unit is disposed on the first cover portion and configured to detect, with an electrical signal, bending in the first cover portion caused by an air pressure difference between an outside pressure and an airtight space that is defined by the main portion, the first cover portion, the second cover portion, and the mounting portion. Meanwhile, the acceleration detecting unit is disposed on the connecting body and configured to detect, with an electrical signal, bending in the connecting body caused by an acceleration imparted on the mass element.

A method of manufacturing a sensor according to an embodiment of the present invention includes: forming a pressure detecting unit and an acceleration detecting unit on a top surface of a substrate, wherein each of the pressure detecting unit and the acceleration detecting unit includes a piezo resistance; and forming a mass element, a frame, and a connecting body by processing the substrate. The mass element includes the pressure detecting unit, the frame surrounds the mass element in plan view, and the connecting body includes the acceleration detecting unit, and further includes one end connected to the frame and the other end connected to the mass element.

The forming a mass element includes: forming a first cover portion by forming a recess portion in a surface of the substrate on the opposite side from a surface where the pressure detecting unit is formed, and thinning a part of the substrate so that a bottom face of the recess portion overlapping with a region where the pressure detecting unit is formed is flexible; making a part of a side wall of the recess portion continued from the first cover portion to a mounting portion; and forming an airtight space by making a second cover portion that covers the recess portion.

According to the embodiments described above, a small-sized sensor capable of detecting at least an acceleration and an air pressure can be obtained as a single structure.

### BRIEF DESCRIPTION OF DRAWINGS

FIG. 1 is a plan view illustrating the overall configuration of a sensor according to an embodiment of the present invention.

FIG. 2 is a cross-sectional view illustrating the overall configuration of the sensor according to the embodiment of the present invention.

FIGS. 3A to 3C are plan views and cross-sectional views illustrating steps in a method of manufacturing the sensor according to the embodiment of the present invention.

FIG. 4 is a cross-sectional view illustrating a step following the steps illustrated in FIGS. 3A to 3C.

### DESCRIPTION OF EMBODIMENTS

An embodiment of a sensor according to the present invention will be described with reference to the drawings.

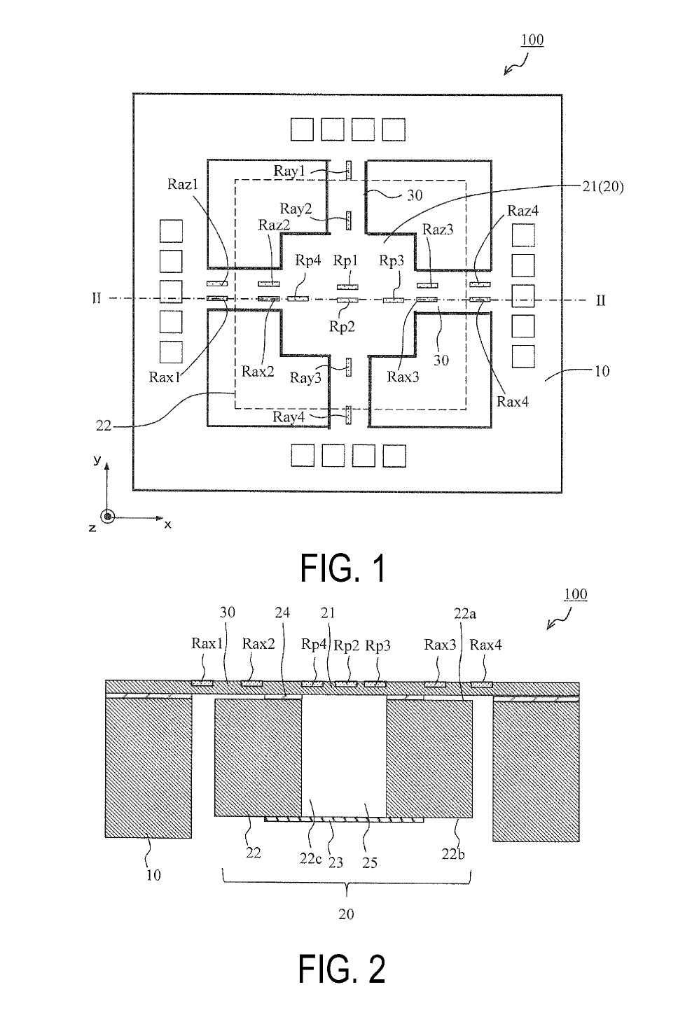

FIG. 1 is a plan view of a sensor 100 according to an embodiment of the present invention, and FIG. 2 is a cross-sectional view taken from a II-II line in FIG. 1. The sensor 100 includes a frame 10, a mass element 20 located on an inner side of the frame 10, connecting bodies 30 that connect the frame 10 to the mass element 20, pressure detecting units Rp configured to detect a pressure, and acceleration detecting units Ra configured to detect an acceleration. These elements will be described in detail below.

The mass element 20 includes a first cover portion 21, a main portion 22, a second cover portion 23, and a mounting portion 24 that mounts the first cover portion 21 to the main portion, and these elements define an airtight space 25 in the interior.

When an acceleration is imparted on the sensor 100, a force corresponding to the acceleration acts on the mass element 20, and the connecting bodies 30 bend in response to the mass element 20 moving. An electrical signal corresponding to the amount by which the connecting bodies 30 bend is detected by the acceleration detecting units Ra, and the acceleration is detected by obtaining and processing that electrical signal using electrical wiring (not illustrated).

Meanwhile, when the sensor 100 is placed in an atmosphere having a given air pressure, the first cover portion 21 bends in accordance with a pressure difference between the atmosphere within the airtight space 25 in the interior of the mass element 20 and the external atmosphere. An electrical signal corresponding to the amount by which the first cover portion 21 bends is detected by the pressure detecting units Rp, and the air pressure is detected by obtaining and processing that electrical signal using electrical wiring (not illustrated).

The mass element 20 has, along with the first cover portion 21 and the main portion 22, a substantially square planar shape, and these elements are disposed such that their centers overlap with each other. In FIG. 1, the planar shape of the main portion 22, which is located toward the bottom, is indicated by a broken line. The size of the first cover portion 21 is set such that the length of one side of the substantially square shape is from 0.25 to 0.5 mm, for example. The thickness of the first cover portion 21 is set to from 5 to 20 μm, for example. Employing such a shape makes the first cover portion 21 flexible. The size of the main portion 22 is set such that the length of one side of the substantially square shape is from 0.4 to 0.65 mm, for example. The thickness of the main portion 22 is set to from 0.2 to 0.625 mm, for example. The first cover portion 21 and the main portion 22 are connected by the mounting portion 24. To rephrase, the mounting portion 24 provides a gap between the first cover portion 21 and the main portion 22 such that the first cover portion 21 can deform and the main portion 22 can displace. The mounting portion 24 has a shape that defines a closed space on the bottom surface side of the first cover portion 21 and surrounds an outer edge portion thereof. In this example, the mounting portion 24 has a substantially square ring shape, corresponding to the shape of the first cover portion 21. The thickness of the mounting portion 24 is set to 1 μm, for example. The first cover portion 21, the main portion 22, and the mounting portion 24 are formed integrally by processing a silicon on insulator (SOI) substrate, for example.

Note that the planar shapes of the first cover portion 21 and the main portion 22 are not limited to square shapes, and any desired shapes, such as circles, rectangles, or polygons, are possible.

A through-hole 22c is formed in the main portion 22 and passes through a top surface 22a and a bottom surface 22b thereof. The through-hole 22c is formed on an inner side of the mounting portion 24 in plan view. The planar shape of the through-hole 22c is a substantially square shape, corresponding to the shape of the mounting portion 24. However, the planar shape of the through-hole 22c is not limited to a square shape, and any desired shape, such as a circle, rectangle, or polygon, is possible. The through-hole 22c has substantially the same shape on the top surface 22a side and the bottom surface 22b side and progresses from the top surface 22a to the bottom surface 22b in a straight line. However, the through-hole 22c is not limited to this shape, and may instead have a tapered shape, an inverted tapered shape, or the like.

The second cover portion 23 is disposed covering the through-hole 22c on the bottom surface 22b side thereof. The planar shape of the second cover portion 23 is not particular limited as long as the through-hole 22c is covered, but may have substantially the same shape as the first cover portion 1, for example. The thickness of the second cover portion 23 is set as appropriate, in consideration of the material thereof, so that the second cover portion 23 deforms less than the first cover portion 21 when a force is applied thereto, and may be set to approximately 0.1 mm, for example. It is preferable to employ a material that can define the airtight space 25 along with the first cover portion 21, the main portion 22, and the mounting portion 24 by sealing the through-hole 22c and ensuring the airtight space 25 is airtight as the material for forming the second cover portion 23. A metal material such as aluminum (Al) or molybdenum (Mo), glass, ceramics, a semiconductor, or the like can be suitably used as such a material. The second cover portion 23 may be bonded to the bottom surface 22b of the main portion 22 using a bonding member such as a brazing material, solder, or an organic resin.

The atmosphere in the airtight space 25 can be set to a vacuum, ambient atmosphere, an inert gas, or the like as suitable. The atmosphere of the airtight space 25 is set to a lower-pressure environment than atmospheric pressure. In this case, the first cover portion 21 deforms so as to bend toward the airtight space 25 in the case where the sensor 100 is placed under atmospheric pressure. An electrical signal corresponding to that bending is detected from the pressure detecting units Rp, which are formed on the top surface of the first cover portion 21.

Although the pressure in the atmosphere of the airtight space 25 may be set higher than atmospheric pressure, it is preferable that the pressure be set low in order to reduce the influence of changes in temperature, and further preferable that the atmosphere be set to a vacuum.

According to the present embodiment, the second cover portion 23 deforms less than the first cover portion 21 when a force is applied thereto, and thus the first cover portion 21 is the element, among the inner walls that define the airtight space 25, that deforms the most in response to air pressure differences. Here, the stress detecting units Rp are disposed on the first cover portion 21, and thus the pressure difference can be detected with a high level of sensitivity. Furthermore, by setting the amount by which the second cover portion 23 deforms when a force is applied thereto to be extremely low, at approximately the same as the amount by which the main portion 22 deforms, the sensitivity of the pressure sensor can be increased further.

Although details will be given later, according to the present embodiment, the pressure detecting units Rp are made from resistive elements such as piezo resistances. The pressure detecting units Rp include Rp1 and Rp2, which are formed near the center of the first cover portion 21, and Rp3 and Rp4, which are formed in an outer peripheral portion of a region of the first cover portion 21 that can displace. Here, the outer peripheral portion of the region of the first cover portion 21 that can displace refers to a region continuing from an inner side of the mounting portion 24 when viewed in plan view. By providing the pressure detecting units Rp1 to Rp4 in this manner, in the case where a central portion of the first cover portion 21 bends so as to sink downward, for example, stress contracting in a longitudinal direction acts on the pressure detecting units Rp1 and Rp2 and stress extending in the longitudinal direction acts on the pressure detecting units Rp3 and Rp4. The air pressure can be sensed by using the pressure detecting units Rp1 to Rp4 to detect electrical signals corresponding to these stresses.

The frame-shaped frame 10 is provided enclosing the mass element 20. The frame 10 has a substantially square planar shape, and has a substantially square opening in its center portion, the opening being slightly larger than the mass element 20. The length of one side of the frame 10 is set to from 1.4 to 3.0 mm, for example, and the width of arms that form the frame 10 (that is, the width of the arm in a direction orthogonal to the longitudinal direction of the arm) is set to from 0.3 to 1.8 mm, for example. The thickness of the frame 10 is set to from 0.2 to 0.625 mm, for example.

As illustrated in FIG. 1, the connecting bodies 30 are provided between the frame 10 and the mass element 20. One end of each connecting body 30 is linked to a center portion in a top surface side of a corresponding inner peripheral surface of the frame 10, and the other end of the connecting body 30 is linked to a center portion in a top surface of a corresponding outer peripheral surface of the first cover portion 21 of the mass element 20. According to the sensor 100 of the present embodiment, four connecting bodies 30 are provided; two of the four connecting bodies 30 are disposed in the same linear shape, extending in an X axis direction with the mass element 20 interposed therebetween, whereas the other two connecting bodies 30 are disposed in the same linear shape, extending in a Y axis direction with the mass element 20 interposed therebetween. Note that the planar shapes of the connecting bodies 30 are not limited to straight lines as illustrated in FIG. 1, and may be curved shapes, bent shapes, or the like.

The connecting bodies 30 are flexible; the mass element 20 moves when an acceleration is imparted on the sensor 100, and the connecting bodies 30 bend in response to the movement of the mass element 20. The length of the connecting bodies 30 in the longitudinal direction is set to from 0.3 to 0.8 mm, the width (the length in a direction orthogonal to the longitudinal direction) is set to from 0.04 to 0.2 mm, and the thickness is set to from 5 to 20 μm, for example. The connecting bodies 30 are made flexible by being formed so as to be long, narrow, and thin in this manner.

As illustrated in FIG. 1, acceleration detecting units Rax1 to Rax4, Ray1 to Ray4, and Raz1 to Raz4, which are resistive elements, are formed on top surfaces of the connecting bodies 30 (when discussed collectively, these resistive elements will be indicated by the reference numeral Ra hereinafter). The acceleration detecting units Rax1 to Rax4, Ray1 to Ray4, and Raz1 to Raz4 are formed in predetermined locations of the connecting bodies 30 and wire-bounded to configure a bridge circuit, so as to be capable of detecting acceleration in three axial directions (the X axis direction, Y axis direction, and Z axis direction in a three-dimensional orthogonal coordinate system, indicated in FIG. 1).

The acceleration detecting units Rax1 to Rax4, Ray1 to Ray4, and Raz1 to Raz4 and the above-described pressure detecting units Rp1 to Rp4 can be formed by, for example, forming a resistive material film in the uppermost layer of an SOI substrate through boron (B) implantation and then patterning the resistive material film into a predetermined shape through etching or the like. The acceleration detecting units Ra and the pressure detecting units Rp, which include piezo resistive elements, can be formed as a result.

In the case where the acceleration detecting units Ra and the pressure detecting units Rp include piezo resistive elements are used, resistance values thereof change in response to deformation caused by bending in the first cover portion 21 and the connecting bodies 30. Changes in output voltages based on the changes in resistance values are obtained as electrical signals, and by processing the electrical signals with an external IC, a direction and magnitude of imparted acceleration or an increase/decrease and magnitude of pressure can be detected.

Note that wiring electrically connected from the acceleration detecting units Ra and the pressure detecting units Rp, pad electrodes for conducting the signals to the external IC or the like, and the like are provided on the top surfaces of the frame 10, the first cover portion 21, and the connecting bodies 30, and the electrical signals are conducted to the exterior through these elements.

This wiring is made from aluminum, an aluminum alloy, or the like, and is formed on the top surfaces of the frame 10, the first cover portion 21, and the connecting bodies 30 by depositing the material through the sputtering method or the like and then patterning the deposited material into a predetermined shape, for example.

According to the sensor 100 configured in this manner, the airtight space 25 can be defined in the interior of the mass element 20 for functioning as an acceleration sensor, and thus the sensor 100 can be provided with the functionality of an air pressure sensor without increasing the size of the sensor 100.

Furthermore, the airtight space 25 is provided expanding across almost the entire thickness of the mass element 20, and thus the airtight space 25 can be made larger. This configuration increases the sensitivity with respect to pressure changes, and ensures the sensor to function as a high-precision air pressure sensor.

Note that when the mass element 20 is viewed in plan view, the centroid of the mass element 20 may be set to overlap with the through-hole 22c, and a weight distribution of the mass element 20 may be biased and an outer side of the mounting portion 24 may be heavier than an inner side of the mounting portion 24, as in the present embodiment. In this case, when a force acts on the mass element 20 and the mass element 20 displaces, a velocity of the mass element 20 contains a large outer peripheral direction (XY direction) component rather than containing a large downward (Z axis direction) component, as with a pendulum; as such, the sensitivity as an acceleration sensor can be increased.

In particular, in the sensor 100, a weight component of the mass element 20 is present on an outer side of the region of the first cover portion 21, which functions as a pressure-sensitive membrane, that can bend. This configuration makes it possible to bias the weight distribution of the mass element 20 further in the outer peripheral direction. Moreover, this weight distribution is effective across almost the entire region (a region of 90% or greater) in the thickness direction of the mass element 20. This weight distribution enables the sensor 100 to function as a sensor having a high acceleration detection sensitivity.

Additionally, in the sensor 100, the frame 10, the first cover portion 21, and the connecting bodies 30 may be formed integrally, as in the present embodiment. In this case, a high-strength and highly-reliable sensor can be provided. Furthermore, all of the constituent elements aside from the second cover portion 23 may be formed integrally, as in this example; this configuration makes it possible for the sensor 100 to be even more reliable.

Furthermore, in the sensor 100, the acceleration detecting units Ra and the pressure detecting units Rp may include a piezo resistance, as in the present embodiment. It is necessary to expose the sensor to the external atmosphere when sensing an air pressure. A typical capacitive sensor requires an electrode opposing a sensor element, and the electrode is provided in a package that hermetically seals the sensor element. It is therefore difficult to incorporate the air pressure sensor into the same element as the acceleration sensor. However, using a piezo resistance as in the present embodiment makes it possible to sense air pressure and acceleration using only the sensor 100. The acceleration sensor and the air pressure sensor can therefore be realized as a single unit. The effects of damping in small spaces can be suppressed as well.

According to the sensor 100 of the present embodiment as described thus far, a sensor capable of detecting at least an air pressure and an acceleration can be realized as a single structure, without an increase in size, and a highly-sensitive sensor can be realized. Note that an angular velocity can also be detected by causing the mass element 20 to rotate in the XY plane. The mass element 20 may be caused to rotate by, for example, providing electrodes on an outer peripheral surface of the main portion 22 and an inner peripheral surface of the frame 10 that face each other and producing electrostatic attraction, or generating a magnetic force on an outer side of the sensor 100.

### Modified Example

Although the main portion 22 is formed by processing an SOI substrate in the above-described example, the main portion 22 may be formed by connecting individual members. In this case, using a denser material makes it possible to increase the force produced by the same acceleration, which in turn makes it possible to increase the amount by which the connecting bodies 30 bend. This configuration makes it possible to provide a sensor with an even higher sensitivity.

Note that in the case where a main portion 22 made from individual members is used, a member made by forming the main portion 22 and the second cover portion 23 integrally may be used. Specifically, the configuration may be such that a member having a recess portion is connected to the first cover portion 21 with the mounting portion 24 interposed therebetween, with the opening side of the recess portion facing the first cover portion 21. In this case, a bottom face of the recess portion functions as the second cover portion 23. Employing such a configuration makes it possible to ensure airtightness and strength between the main portion 22 and the second cover portion 23; additionally, the shape of the airtight space 25 can be realized with precision by controlling the shape of the recess portion. This configuration makes it possible to provide a highly-reliable sensor.

In such a case where a member made by forming the main portion 22 and the second cover portion 23 integrally is used, the depth of the recess portion is preferably no less than 50%, and further preferably no less than 90%, of the overall thickness of the member. Forming the shape of the recess portion in this manner makes it possible to shift the weight distribution of the mass element 20 to the outer side rather than the inner side of the mounting portion 24, when the mass element 20 is viewed in plan view; this configuration makes it possible to make the sensor more sensitive.

Although the foregoing describes an example in which the air pressure detecting units Rp and the acceleration detecting units Ra include a piezo resistance, the units are not limited thereto as long as the units are capable of detecting bending in the first cover portion 21 and the connecting bodies 30.

For example, the air pressure detecting units Rp and the acceleration detecting units Ra may be electrodes, and the magnitude and direction of bending in the first cover portion 21 and the connecting bodies 30 may be detected as electrical signals on the basis of changes in an electrostatic capacitance. In this case, an anchoring portion spaced from the first cover portion 21 and the connecting bodies 30 is newly provided and electrodes that oppose the air pressure detecting units Rp and the acceleration detecting units Ra are provided on the anchoring portion. The electrostatic capacitance may be measured by causing the electrodes on the anchoring portion side and the air pressure detecting unit Rp and acceleration detecting unit Ra sides to function as a pair of electrodes. Note that in this case, it is necessary to provide the anchoring portion so that the sensor is not shielded from the external atmosphere by the anchoring portion.

Additionally, although the foregoing describes an example in which the through-hole 22c is formed in only one location, in the center portion of the main portion 22, the through-hole 22c may be provided in a plurality of locations. For example, sub through-holes may be formed in regions that do not overlap with the connecting bodies 30 in the top surface view. Adjusting the locations where the sub through-holes are formed, the sizes of the sub through-holes, and the like makes it possible to correct the detection sensitivity in the case where the sensor 100 has different detection sensitivities in the XY directions.

### Method of Manufacturing Sensor 100

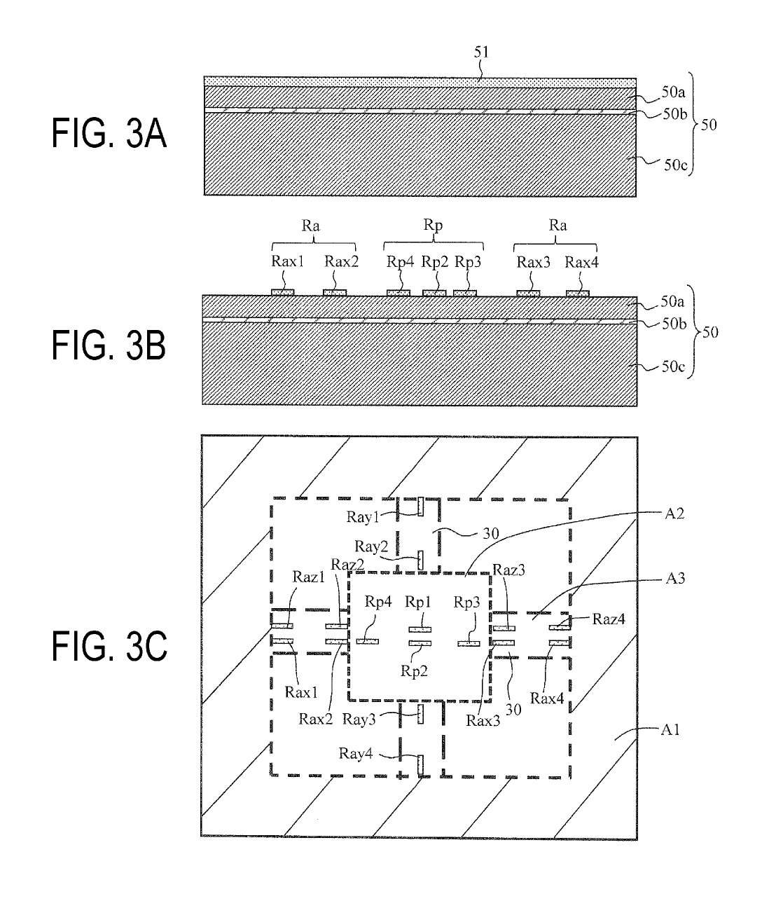

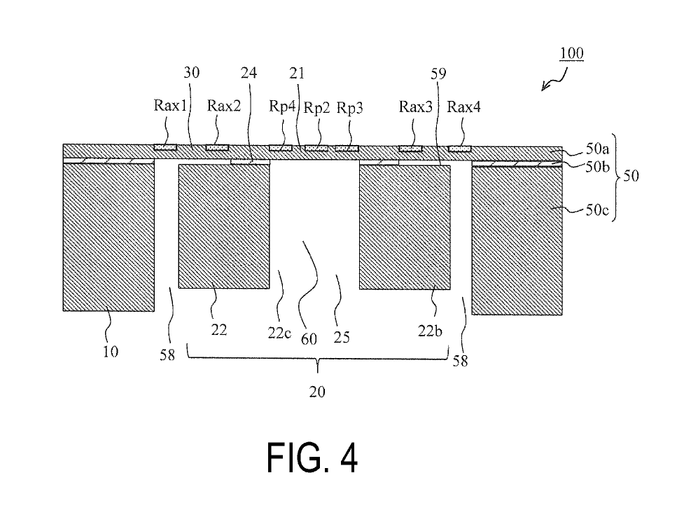

Next, a method of manufacturing the above-described sensor 100 will be described using FIGS. 3A to 4.

Note that FIGS. 3A and 3B are cross-sectional views corresponding to cross-sections taken from the II-II line indicated in FIG. 1, and FIG. 3C is a top surface view. FIG. 4 is a cross-sectional view corresponding to a cross-section taken from the II-II line indicated in FIG. 1.

### Detecting Unit Formation Process

First, a resistive material film 51 is formed on the top surface of a substrate 50, as indicated in FIG. 3A.

The substrate 50 is, for example, an SOI substrate, and includes a laminated structure in which a first layer 50a made from Si, a second layer 50b made from SiO₂, and a third layer 50c made from Si are laminated in that order. The first layer 50a is approximately 10 μm thick, the second layer 50b is approximately 1 μm thick, and the third layer 50c is approximately 500 μm thick.

The resistive material film 51 is formed by using an ion implantation method to implant boron, arsenic (As), or the like in a main surface of the first layer 50a of the substrate 50 made from a SOI substrate. The resistive material film 51 has, for example, an impurity concentration of 1×10¹⁸ atms/cm³ at the surface of the first layer 50a, and a depth of approximately 0.5 μm.

Next, as illustrated in FIG. 3B, the resistive material film 51 is partially removed so that the resistive material film 51 serves as the air pressure detecting units Rp and the acceleration detecting units Ra, formed in desired shapes at desired locations on the top surface of the substrate 50.

In this step, for example, a resist film corresponding to the shapes of the air pressure detecting units Rp and the acceleration detecting units Ra is formed on the resistive material film 51, and the resistive material film 51 exposed from the resist film is then removed through an etching process such as RIE etching. The resist film is then removed, completing the formation of the air pressure detecting units Rp and the acceleration detecting units Ra on the top surface.

After the air pressure detecting units Rp and the acceleration detecting units Ra have been formed, wiring and element-side electrode pads (not illustrated) to be connected to the air pressure detecting units Rp and the acceleration detecting units Ra are formed. The wiring and element-side electrode pads can be formed by, for example, depositing a metal material such as aluminum through the sputtering method and then patterning the deposited material into predetermined shapes through dry etching or the like.

### Forming Process

Next, the mass element 20 including the pressure detecting units Rp, the frame 10 surrounding the mass element 20, and the connecting bodies 30 including the acceleration detecting units Ra and further including one end connected to the frame 10 and the other end connected to the mass element 20 are formed by processing the substrate 50 on which the air pressure detecting units Rp and the acceleration detecting units Ra have been formed.

Specifically, first, as illustrated in FIG. 3C, the first layer 50a is patterned into a desired shape from the first layer 50a side of the substrate 50 (a first patterning process). In other words, a frame-shaped first region A1, a second region A2 located on an inner side of the first region A1, and a beam-shaped third region A3 connecting the first region A1 and the second region A2 are established, and regions of the first layer 50a aside from the first to third regions A1, A2, and A3 are removed. Here, the pressure detecting units Rp are disposed in the second region and the acceleration detecting units Ra are disposed in the third region.

Next, as illustrated in FIG. 4, an annular groove 58 for defining a closed space in plan view is formed on an inner side of the first region A1 from the third layer 30c side of the substrate 50. The groove 58 is formed between the first region A1 and the second region A2, and the third layer 50c and the second layer 50b at that area are removed so as to expose the bottom surface of the first layer 50a. By forming the groove 58, the frame 10 is formed from a laminated body of the first layer 50a, the second layer 50b, and the third layer 50c present in a continuous manner from an outer peripheral portion of the substrate 50. To rephrase, the frame 10 is separated from other areas by the groove 58.

Furthermore, in plan view, a space 59 is formed between the first layer 50a and the third layer 50c by removing the second layer 50b, from the third layer 50c side of the substrate 50, in a region spanning from an inner side of the first region A1 to the second region A2. This space 59 separates the first layer 50a in the third region A3 from the other areas in the thickness direction, resulting in the beam-shaped connecting body 30. One end of the connecting body 30 is formed integrally with the first layer 50a in the first region A1 (the frame 10) and produces a seamless integrated structure with no bonded portions, which improves the durability. The other end of the connecting body 30 is formed integrally with the first layer 50a in the second region A2 (the mass element 20) and produces a seamless integrated structure with no bonded portions, which improves the durability.

Next, a method of forming the mass element 20 will be described in detail.

A recess portion 60 is formed from the third layer 50c side of the substrate 50, in an inner-side region aside from the outer peripheral portion of the second region A2 in plan view, thus making the substrate 50 thinner. A bottom face portion of the recess portion 60 is made flexible by being thinned in this manner. Specifically, the recess portion 60 is formed by removing the third layer 50c and the second layer 50b and exposing the first layer 50a.

A region formed in this manner, corresponding to the second region A2 of the first layer 50a, serves as the first cover portion 21. Of the first cover portion 21, an area in which there is no layer making direct contact with the bottom surface thereof functions as a flexible pressure-sensitive membrane, and the pressure detecting units Rp are formed in the pressure-sensitive membrane.

An upper end portion that forms side walls of the recess portion 60, or in other words, the second layer 50b that makes contact with the first cover portion 21, functions as the mounting portion 24. The mounting portion 24 has a shape that, in plan view, surrounds an outer periphery of the recess portion 60. Note that the mounting portion 24 is formed by removing the second layer 50b from two directions, namely from the frame 10 side and the pressure detecting unit Rp side, and produces an annular shape. Specifically, the mounting portion 24 is formed in two stages. The first stage is carried out when forming the connecting body 30, by removing the second layer 50b in a region spanning from the frame 10 side (from an inner side of the first region A1) to the second region A2. The second stage is carried out when forming the recess portion 60, by removing the second layer 50b while leaving part of the outer peripheral portion of the second region A2. The mounting portion 24 is thus formed in two stages.

The third layer 50c that is connected to the mounting portion 24 and separated from the third layer 50c of the frame 10 but present on an inner side of the frame 10 serves as the main portion 22. Note that in the main portion 22, the third layer 50c may be partially removed in the thickness direction thereof so that the bottom surface of the main portion 22 is positioned higher than the bottom surface of the frame 10.

Next, an opening formed by the recess portion 60 in the main portion 22 is covered from the third layer 50c side by the second cover portion 23 (see FIG. 2). The material and shape of the second cover portion 23 are selected so that the second cover portion 23 does not easily deform when a force is applied thereto. A metal cap is employed in this example. As a result, an interior space defined by the recess portion 60 is sealed by the first cover portion 21, the main portion 22, the second cover portion 23, and the mounting portion 24, thus defining the airtight space 25.

Here, the process of mounting the second cover portion 23 is carried out in a vacuum atmosphere. In other words, the airtight space 25 is in a state of lower pressure than atmospheric pressure.

The sensor 100 including the mass element 20 can be provided by employing such a process.

Note that the substrate 50 can be processed using a conventionally-known semiconductor microfabrication technique such as photolithography or deep dry etching.

By employing this process, the mass element 20 can be obtained by processing a single substrate 50 and forming the shapes aside from the second cover portion 23. This process makes it possible to ensure the strength of the connections between the frame 10 and mass element 20 and the connecting bodies 30, and the strength of the connection between the first cover portion 21 and the mounting portion 24 and main portion 22, which in turn makes it possible to increase the reliability. Furthermore, the first cover portion 21 is connected securely to the mounting portion 24 and the main portion 22 with no gap therebetween. This process makes it possible to increase the airtightness of the airtight space 25, which in turn makes it possible to increase the reliability as an air pressure sensor.

Furthermore, as described above, the shapes of the mass element 20 aside from the second cover portion 23 are formed by processing a single substrate 50. The weight of the second cover portion 23 is extremely lighter than the weight of the main portion 22. As such, the shapes can be formed by patterning a part of the mass element 20 that contains the majority of the weight thereof. This process makes it possible to realize a desired centroid position and weight distribution for the mass element 20 with a high level of precision, and thus the sensor 100 can be provided with a high level of productivity while also ensuring a stable level of precision.

Additionally, by forming the recess portion 60 after the connecting bodies 30 are formed as in the above-described example, processing widths such as beam widths, processing thicknesses, pattern skew, and the like of the connecting bodies 30 can be corrected by the recess portion 60.

Additionally, the airtight space 25 is defined by the second cover portion 23 in the final process of manufacturing the sensor 100. Accordingly, the vacuum degree (air pressure) of the atmosphere sealed in the airtight space 25 can be adjusted in accordance with variation in the processing precision in the processes carried out up until that point or variation in properties, which makes it possible to provide a sensor 100 having little variation in sensing precision.

### Modified Example

The foregoing describes an example in which the resistive material film 51 is formed, after which the resistive material film 51 is processed into desired shapes to serve as the air pressure detecting units Rp and the acceleration detecting units Ra. However, the air pressure detecting units Rp and the acceleration detecting units Ra may be formed by forming a resist film on the top surface of the first layer 50a in advance, removing the resist film from regions in which the air pressure detecting units Rp and the acceleration detecting units Ra are to be formed, and diffusing impurities only in desired locations (openings in the resist film). In this case, the air pressure detecting units Rp and the acceleration detecting units Ra are flush with the top surface of the substrate 50, eliminating non-planarities therein, which makes it easy to electrically connect the wiring that is connected to the air pressure detecting units Rp and the acceleration detecting units Ra.

### REFERENCE SIGNS LIST

10 Frame
20 Mass element
21 First cover portion
22 Main portion
22a Top surface
22b Bottom surface
22c Through-hole
23 Second cover portion
24 Mounting portion
25 Airtight space
30 Connecting body
50 Substrate
50a First layer
50b Second layer
50c Third layer
100 Sensor

1. A sensor comprising:
a mass element;
a frame surrounding the mass element in a top surface view;
a connecting body having flexibility, and connecting the mass element to the frame;
a pressure detecting unit; and
an acceleration detecting unit,
wherein the mass element comprises:
a main portion comprising a top surface, a bottom surface, and a through-hole passing therethrough from the top surface to the bottom surface;
a mounting portion connected to the top surface of the main portion, and surrounding an outer periphery of the through-hole;
a first cover portion having flexibility, connected to the mounting portion and covering the through-hole; and
a second cover portion, disposed on the bottom surface of the main portion, covering the through-hole, and deformable less than the first cover portion when received an external force,
wherein the pressure detecting unit is disposed on the first cover portion and configured to detect, with an electrical signal, bending in the first cover portion caused by an air pressure difference between an outside pressure and an airtight space that is defined by the main portion, the first cover portion, the second cover portion, and the mounting portion, and
wherein the acceleration detecting unit is disposed on the connecting body and configured to detect, with an electrical signal, bending in the connecting body caused by an acceleration imparted on the mass element.

2. The sensor according to claim 1, wherein
a centroid of the mass element overlaps with the through-hole in plan view, and
the mass element has a weight distribution biased and an outer side of the mounting portion is heavier than an inner side of the mounting portion.

3. The sensor according to claim 1, wherein the first cover portion and the connecting body are monolithic structure.

4. The sensor according to claim 1, wherein the second cover portion and the main portion are monolithic structure.

5. A method of manufacturing a sensor, the method comprising:
forming a pressure detecting unit and an acceleration detecting unit on a top surface of a substrate, wherein each of the pressure detecting unit and the acceleration detecting unit comprises a piezo resistance; and
forming a mass element, a frame and a connecting body by processing the substrate,
wherein:
the mass element comprises the pressure detecting unit;
the frame surrounds the mass element in plan view; and
the connecting body comprises the acceleration detecting unit, and further comprises one end connected to the frame and the other end connected to the mass element,
wherein the forming a mass element comprises:
forming a first cover portion by forming a recess portion in a surface of the substrate on the opposite side from a surface where the pressure detecting unit is formed, and thinning a part of the substrate so that a bottom face of the recess portion overlapping with a region where the pressure detecting unit is formed is flexible;
making a part of a side wall of the recess portion continued from the first cover portion to a mounting portion; and
forming an airtight space by making a second cover portion that covers the recess portion.

6. The sensor according to claim 1, a weight of the second cover portion is lighter than a weight of the main portion.

7. The sensor according to claim 1, the thickness of the second cover portion is shorter than the depth of the through-hole.
